(19) United States
(12) Patent Application Publication
(10) Pub. No.: US 2023/0125689 A1
(43) Pub. Date: Apr. 27, 2023

(54) BATTERY ARRANGEMENT WITH AN EXTINGUISHING DEVICE AND MOTOR VEHICLE

(71) Applicant: AUDI AG, Ingolstadt (DE)

(72) Inventors: Dirk BAEDER, Fellbach (DE); Michael GRABOWSKI, Ingolstadt (DE)

(73) Assignee: AUDI AG, Ingolstadt (DE)

(21) Appl. No.: 17/971,876

(22) Filed: Oct. 24, 2022

(30) Foreign Application Priority Data
Oct. 25, 2021 (DE) 102021127617.9

(51) Int. Cl. H01M 50/24; A62C 3/07; A62C 3/16; H01M 50/249; A62C 35/10; A62C 35/02

(52) U.S. Cl. CPC H01M 50/24; A62C 3/07; A62C 3/16; H01M 50/249; A62C 35/10; A62C 35/023; H01M 2220/20

(57) ABSTRACT

A battery arrangement with a battery housing in which at least one battery element is arranged. The battery arrangement includes an extinguishing device which has at least one extinguishing unit which is also arranged in the battery housing. The extinguishing unit includes a housing element and an extinguishing agent which is arranged in a cavity in the housing element. The extinguishing unit has a detonation mechanism which is designed to cause a detonation of the housing element and a release of the extinguishing agent in the form of an aerosol when a predetermined fire condition, which results from a fire in the at least one battery element, is present.

### FIELD

The invention relates to a battery arrangement for a motor vehicle with an extinguishing device. The battery arrangement comprises at least one battery element which is arranged in a battery housing. The extinguishing device is designed to provide an extinguishing agent in the form of an aerosol for extinguishing the at least one battery element when a predetermined fire condition, which results from a fire in the at least one battery element, is present. The invention also relates to a motor vehicle with a corresponding battery arrangement.

### BACKGROUND

Motor vehicles are known in which a drive battery or traction battery is used to operate an electric drive, such as of an e-machine of the motor vehicle, or an on-board network. Such a motor vehicle is referred to as a battery electric vehicle, for example, and can be an electric vehicle or a hybrid vehicle, for example. In order to provide electrical energy to the motor vehicle, the drive battery comprises at least one battery element, i.e. one or more battery elements. A battery element can be a so-called battery cell or galvanic cell, for example. The battery cell is an electrochemical energy store that is designed to provide electrical energy by means of chemical reactions of an active material. The amount of electrical energy that can be provided depends, for example, on the cell technology or electrochemistry used, i.e. for example on a configuration of the active material. Lithium-ion technology or lithium-iron phosphate technology, for example, are known as cell technologies. Alternatively, the battery cell can be designed as a solid-state battery, for example.

To form the drive battery, one or more battery cells can be electrically connected to one another in a suitable manner. The number of connected battery cells can depend on a desired amount of energy that the drive battery is intended to provide to the motor vehicle. The battery cells can, for example, be arranged directly in a battery housing (cell-to-car) in order to use the drive battery in the motor vehicle. Alternatively, several battery cells can first be combined in a so-called battery module (cell-to-pack) and then one or more battery modules can be arranged in the battery housing.

Under certain conditions, thermal runaway can occur when operating the drive battery. This means that the respective battery element overheats, so that the battery temperature exceeds a predetermined reaction temperature limit value. For example, the reaction temperature limit value may depend on the battery technology used. For example, with the aforementioned lithium-ion technology, the reaction temperature limit value may be about 84° C. If the battery element exceeds the reaction temperature limit value, an unstoppable endothermic chemical reaction can take place in the active material. Within a few seconds, for example within two to three seconds, the battery element releases about 60 percent of the stored energy in the form of thermal energy. The battery element catches fire. The battery element is therefore in the fire condition mentioned at the outset.

An extinguishing device can be used to prevent thermal propagation of the heat energy generated to other components of the motor vehicle or to further battery elements of the drive battery. The extinguishing device can provide an extinguishing agent for extinguishing the battery element or at least for extracting the thermal energy. In order to achieve the best possible extinguishing effect, the extinguishing agent can be provided in the form of an aerosol, for example. An aerosol is a heterogeneous mixture of particles or suspended particles of a solid or liquid material in a gaseous medium such as air. The particles or aerosol particles can be present in different dimensions or sizes and have, for example, a diameter of about 1 nanometer up to several 100 micrometers.

To provide the extinguishing agent for extinguishing, the extinguishing device can atomize the extinguishing agent into the aerosol particles, for example. For example, for atomization, the extinguishing agent can be discharged explosively. The extinguishing agent in the form of the aerosol has a high specific surface area. As a result, the extinguishing agent can absorb the thermal energy that is present in the fire condition particularly quickly. The heat transfer from the source of the fire, i.e. from the burning battery element, to the extinguishing agent can be accelerated considerably. This can lead to evaporation of the aerosol particles in the aerosol. Evaporation is an endothermic reaction and thus absorbs the thermal energy as reaction energy. The so-called evaporative cooling occurs. As a result, the thermal energy can be withdrawn from the fire and the fire can be extinguished.

Different options for configuring an extinguishing device are known, for example, from the prior art.

For example, CN 112043995 A discloses a fire extinguishing mechanism for detecting and extinguishing lithium-ion batteries with thermal runway. A fire extinguisher is used for this purpose, which can provide an extinguishing agent to each individual battery cell of a drive battery via a respective supply line.

WO 2020/214850 A1 discloses a method for cooling a battery cell, for example. A cooling liquid is atomized by means a micro nozzle, so that liquid aerosol particles are created. These are provided to the battery cell.

For example, JP 2014-090782 A discloses a battery module which comprises a plurality of sodium-sulfur battery cells in a housing. A fire extinguisher is connected to the housing via a supply line. When a fire is detected in the housing, a solid extinguishing agent is burned in an extinguishing body of the fire extinguisher, so that an aerosol is created. The aerosol is provided via the supply line to the battery cells in the housing.

In the prior art, the extinguishing agent for extinguishing the battery fire is thus supplied from outside the battery housing. This requires additional components, such as supply lines. In addition, depending on a material from which they are formed, the supply lines can be susceptible to defects from the fire, so that the functionality of the extinguishing device can be restricted. In addition, the provision of the extinguishing agent can be delayed as a result.

### SUMMARY

It is the object of the present invention to provide an extinguishing device with an aerosol extinguishing agent which can reliably extinguish a battery fire.

The invention proposes a battery arrangement for a motor vehicle with an extinguishing device for reliable extinguishing. The battery arrangement comprises at least one battery element, which can be designed as a battery cell or a battery module, for example. The battery element is arranged in a battery housing. The battery housing and the at least one battery element can together form the drive battery described above. The extinguishing device is designed to provide an extinguishing agent in the form of an aerosol for extinguishing the at least one battery element when a predetermined fire condition, which results from a fire in the at least one battery element, is present, for example detected. The extinguishing agent of the extinguishing device itself can already be present in the form of an aerosol, for example, or the extinguishing agent can be used to form aerosol particles, which then form the aerosol with ambient air. In order to extinguish the at least one battery element, the extinguishing device comprises at least one extinguishing unit. The extinguishing unit is arranged in the battery housing together with the at least one battery element. The extinguishing unit comprises a housing element which has a cavity. The extinguishing agent is arranged or introduced in the cavity. The housing element thus forms a shell or a container for the extinguishing agent. As a result, the extinguishing agent can be held in the housing element.

Furthermore, the extinguishing unit has a detonation mechanism which is designed to cause a detonation of the housing element and a release of the extinguishing agent in the form of the aerosol when the predetermined fire condition is present. The extinguishing unit can thus be referred to as an explosive aerosol extinguishing unit. As a result of the detonation of the housing element, the extinguishing agent is thus ejected omnidirectionally, i.e. in all directions, from the housing and distributed in the battery housing. The dimension of the aerosol particles of the extinguishing agent can depend, for example, on a detonation pulse of the detonation.

The extinguishing unit of the extinguishing device is thus arranged directly in the battery housing. The extinguishing agent can therefore be provided immediately if required. Delays, for example due to the external introduction of the extinguishing agent, are eliminated. There is also no need for additional supply lines for introducing or supplying the extinguishing agent from outside the battery housing. Thus, costs and weight for the extinguishing device can be saved. In addition, the extinguishing device requires less installation space as a result.

An effect of the detonation of the housing element can be limited locally to the extinguishing unit or the battery housing, for example. That is, the detonation pulse of the detonation mechanism can be adapted to the battery housing. This ensures that the battery housing remains intact in the event of a detonation or explosion of the extinguishing unit.

For example, the housing element may have a rigid or deformable material. When molding the housing element from the material, the material can be present in a low density. This ensures that no fragmentation is created during the detonation. A polystyrene, for example, is suitable for molding the housing element. Additionally or alternatively, the housing element can have paper as the material, for example. A wall thickness or strength of the housing element can be adapted to an overall dimension of the extinguishing unit, for example. For example, the wall thickness can be between 0.1 to 1 centimeter. For example, polystyrene or paper or a duromer or a fiber-reinforced plastic is suitable as a material for the housing element. Glass fibers or carbon fibers (carbon nano tubes), for example, can be used for fiber reinforcement.

For example, the extinguishing agent can comprise one or more extinguishing materials. For example, water or a coolant for a known battery cooling circuit or other known substances or materials that are suitable for extinguishing a battery fire can be used as the extinguishing material. Such materials develop their extinguishing effect mainly by withdrawing thermal energy from the source of the fire, i.e. the burning battery element. Such an extinguishing material may be referred to as a primary extinguishing material, for example. In addition to the primary extinguishing material, the extinguishing agent can also have a secondary extinguishing material. Carbon dioxide or nitrogen, for example, can be used as secondary extinguishing material. The secondary extinguishing material can be used to displace oxygen in the vicinity of the source of the fire and thus remove the flammable substance from the fire.

The invention also comprises embodiments which result in additional advantages. Various possibilities are provided in the invention for triggering the detonation mechanism or for the configuration of the detonation mechanism. This is discussed in more detail in the following embodiments of the invention.

In one embodiment, the extinguishing agent for providing the detonation mechanism has at least one material or substance with a predetermined coefficient of expansion. As a result, the extinguishing agent is designed to cause an increase in pressure in the housing element when the fire condition is present. This increase in pressure is greater by a predetermined limit value than a predetermined elasticity value of the housing element. That is, the detonation mechanism can be provided by the extinguishing unit itself being temperature sensitive. The extinguishing unit can thus automatically detonate or explode as soon as the fire condition is present.

In the present case, the elasticity value means a material limit value for the housing element above which a mechanical load leads to a fracture of the housing element, in this case to detonation. The elasticity limit, i.e. the elasticity value, can be specified, for example, by a modulus of elasticity or a strength or rigidity of a material of the housing element. Sufficient mechanical load can be given, for example, by the pressure increase in the housing element when the extinguishing agent is warmed or heated. The extinguishing agent can be heated by the battery element, which is in the fire condition, transferring its thermal energy to the extinguishing unit. When heated, the extinguishing agent wants to expand. Depending on the material selected, the housing element can counteract the expansion with its rigidity or strength, at least from a certain deformation or volume increase. Thus, the internal pressure in the housing increases. The pressure can increase until the elasticity limit of the material is reached. If the pressure of the extinguishing agent is greater than the elasticity value, the housing detonates. The detonation pulse ensures that the aerosols of the extinguishing agent are distributed in the battery housing. The greater the difference between the internal pressure in the housing and a pressure outside the housing element, i.e. an ambient pressure, the greater the detonation pulse and the smaller the dimensions of the aerosol particles can be.

In order to avoid melting of the housing element, a material can be selected, for example, whose melting temperature is higher than a fire temperature that the battery element has when the fire condition is present. This can prevent the housing element from melting when the battery catches fire. This means that the housing element itself can be designed to be temperature-resistant.

In a further embodiment, the extinguishing unit has a detonation element for providing the detonation mechanism. The detonation element comprises an explosive or a blasting agent as a material. It is designed to detonate when the fire condition is present. That is, in addition to the extinguishing agent, the extinguishing unit can comprise the detonation element with the explosive. The detonation element can, for example, be attached in the housing element together with the extinguishing agent or on the outside of the housing element. The explosive or blasting agent may be a temperature sensitive material. Thus, the detonation element can be designed to be self-igniting. Energetic activation of the explosive can be provided by the thermal energy of the battery element when the fire condition is present.

As an alternative to this, the detonation element can be formed for externally supplied ignition. To this end, a further embodiment provides that the battery arrangement has a monitoring system which is designed to monitor at least one state variable relating to the fire condition. In the event that the state variable has a value that represents the fire condition, the monitoring system is designed to control an ignition mechanism of the detonation element with a trigger signal and to cause or trigger the detonation of the explosive. This means that the extinguishing unit can only be triggered by the control signal or trigger signal from the monitoring system. This results in the advantage that the detonation of the extinguishing unit can be planned or controlled directly. Thus, the reliable triggering of the detonation can be ensured.

The monitoring system can detect, for example, a temperature value of the respective battery element or a temperature value in the battery housing as a state variable. Alternatively or additionally, a pressure in the battery housing, for example, can be detected as a state variable. The monitoring system can have a sensor unit for measuring or detecting the state variable. If the temperature value is measured as the state variable, the sensor unit can comprise a temperature sensor, for example. If a pressure value is measured as the state variable, the sensor unit can comprise a pressure sensor, for example. Alternatively, the pressure value can, for example, be detected indirectly by means of the monitoring system when a pressure compensation valve in the battery housing is triggered.

In the present embodiment, the explosive is energetically activated by means of the ignition mechanism. The ignition mechanism can be, for example, a detonator with an initiating explosive. Alternatively, the ignition mechanism may be provided by means of a piezo element circuit, or a pyrotechnic igniter, or an arc ignition, for example. By using the controllable ignition mechanism, the detonation element in this configuration can, for example, be arranged centrally in the housing element and surrounded by the extinguishing agent. As a result, when the detonation element detonates, the aerosol distribution in the battery housing can be further improved.

The following embodiments now deal with how the extinguishing unit can be attached in the battery housing.

For this purpose, one embodiment provides that in a predetermined installation position of the battery arrangement in a motor vehicle, the extinguishing device is arranged in the battery housing in the direction of gravity above the at least one battery element. As a result, the extinguishing device is designed to cause aerosol particles, which the extinguishing agent has in the aerosol form, to sink in the direction of gravity. This means that the respective extinguishing unit can be arranged, for example, on a lid or an upper side of the respective battery element in the installation position. This results in the advantage that the detonation pulse is promoted during the detonation of the housing element by the effective direction of gravity. As a result, for example, a lower detonation energy, i.e. a lower detonation pulse, is required for the denotation in order to nevertheless cause an effective distribution of the extinguishing agent in the housing.

In a further embodiment, according to a first variant, the extinguishing unit is designed as a plate. In this case, the extinguishing unit is arranged flat in the battery housing at least in a section of a housing wall. For example, the extinguishing unit can be arranged with its largest surface on the housing wall and, for example, completely or partially cover it. This means that the dimension of the extinguishing unit as a plate can be adapted to the dimension of the housing wall. A lid or a base of the battery housing, for example, is suitable as the housing wall in accordance with the installation position described above.

According to a second variant, the extinguishing device can comprise a plurality of extinguishing units which are arranged at predetermined different positions in the battery housing. For example, the extinguishing units can be arranged in a star or cross shape along an inside of one of the housing walls. This means that one extinguishing unit can be attached in the center of the housing wall, for example, while the others can respectively be arranged at a 45-degree angle to one another at the edges or corners of the housing wall.

The extinguishing unit itself can have a predetermined geometric shape. For example, the extinguishing unit can be in the form of a sphere, a cylinder, a cuboid, a pyramid or a cone or some other basic geometric shape. If a plurality of extinguishing units is used, the dimension of the individual extinguishing unit can be adapted to the dimension of at least one side face of the at least one battery element, for example. The respective extinguishing unit can have a diameter of 0.5 to 10 centimeters, for example.

According to a further embodiment, the extinguishing device has a plurality of extinguishing units and also comprises a fixing unit for the plurality of extinguishing units. The fixing unit is designed to hold the extinguishing units in a predetermined normal state of the battery arrangement in a predetermined position in the battery housing. That is, the fixing unit can fix or position the extinguishing units in the battery housing. As a result, the extinguishing units can be held in position on the desired housing wall, for example, as described above. Furthermore, the fixing unit is designed to release the extinguishing units from the predetermined position into the battery housing either when the fire condition is imminent or after detonation of at least one of the extinguishing units when the fire condition is present. That is, the fixing unit can distribute the extinguishing units in the battery house when the fire condition is imminent or when the fire condition is present. This results in the advantage that the extinguishing units are fixed in the battery housing during normal operation of the battery arrangement, i.e. for example when the battery arrangement is used to operate the motor vehicle and as long as the fire condition in not present. It can be avoided that the extinguishing units can thus move freely in the battery housing, for example when driving. In this way, damage to the drive battery or the extinguishing units can be avoided. In addition, interfering noises that could arise when the extinguishing units are moved in the battery housing can be avoided.

The imminent fire condition can be present, for example, when the battery temperature reaches a predetermined trigger temperature limit value. The trigger temperature limit value can, for example, be the reaction temperature limit value described at the outset, from which the thermal runaway has occurred. The trigger temperature limit value can thus be 84° C., for example. Alternatively, of course, a lower or higher trigger temperature limit value is conceivable. For example, the trigger temperature limit value may be set depending on the selected electrochemistry of the battery elements.

In order to be able to release the extinguishing units, the fixing unit has a thermosensitive material, for example. That is, the material may have a melting point that is lower than a temperature that is present when the fire condition is imminent or present in the battery housing or on the respective battery element. In this case, a fixing body of the fixing unit itself can be formed from the thermosensitive material. Alternatively or additionally, at least one fixing element for fixing the fixing body in the battery housing can be formed from the thermosensitive material. When the melting point of the material is reached, a structure of the fixing unit and/or of the fixing body and/or of the fixing element can thus change. For example, a bead of adhesive, a screw or some other fastening means can be used as a fixing element. The fixing body can be in the form of a net or a film, for example.

According to a further embodiment, the battery arrangement has a plurality of battery elements and the extinguishing device has a plurality of extinguishing units. At least one dedicated extinguishing unit is assigned to each battery element. This means that at least one extinguishing unit is assigned or allocated to exactly one battery element. In particular, exactly one extinguishing unit can be assigned to each battery element. This results in the advantage that a targeted extinguishing of individual battery elements can be realized by the respectively assigned extinguishing unit. This means that the assigned extinguishing unit can only detonate, for example, when the fire condition is present for the assigned battery element.

In connection with the assignment, a further embodiment provides that the battery arrangement has a heat protection device with a plurality of heat protection units. One or more dedicated heat protection units are assigned to each battery element. This means that at least one heat protection unit is assigned or allocated to exactly one battery element. The respective heat protection unit comprises a housing element and a heat protection agent. The housing element has a cavity in which the heat protection agent is arranged or introduced. That is, the housing element can form a shell or container for the heat protection agent. The respective heat protection unit has a detonation mechanism which is designed to cause a detonation of the housing element and a release of the heat protection agent in the form of an aerosol to the assigned battery element only if the fire condition is present or imminent for another battery element not assigned to the respective heat protection unit.

This results in the advantage that the remaining or intact battery elements, i.e. the battery elements for which the fire condition does not exist, can be effectively shielded from the battery element that is in the fire condition. This means that a thermal propagation of the thermal energy from the continuous battery element to the intact battery elements can be avoided. For this purpose, the heat protection agent can be present, for example, in the form of a non-reactive or inert dust. The detonation mechanism for the heat protection unit can be designed, for example, as described above for the extinguishing unit. In contrast to the extinguishing unit, the triggering condition for the detonation mechanism of the heat protection unit can already exist when the fire condition is imminent. For example, the fire condition may be classified as imminent if the at least one battery element is at a temperature or the temperature in the battery housing is such that the battery element will inevitably enter the fire condition after a predetermined time, such as a few seconds. The triggering condition can be related, for example, to the initially described reaction limit value for the thermal runaway of the battery element. Depending on the selected battery technology of the battery element, the triggering condition can be present at 84 degrees Celsius, for example.

The invention also relates to a motor vehicle with a battery arrangement as described above. The battery arrangement can be a drive battery or high-voltage battery of the motor vehicle, for example. The motor vehicle can be an automobile, for example, in particular a passenger car or a truck, or a passenger bus or a motorcycle.

The invention also comprises the combinations of the features of the described embodiments. The invention also comprises implementations that each have a combination of the features of several of the described embodiments, unless the embodiments were described as mutually exclusive.

### BRIEF DESCRIPTION OF THE FIGURES

Exemplary embodiments of the invention are described hereinafter. In the figures:

FIG. 1 shows a schematic representation of a battery arrangement with an extinguishing device according to a first exemplary embodiment;

FIG. 2 shows a schematic representation of the battery arrangement with an extinguishing device according to a second exemplary embodiment; and

FIG. 3 shows a schematic representation of a section of the battery arrangement with an extinguishing device according to a third exemplary embodiment.

### DETAILED DESCRIPTION

The exemplary embodiments explained hereinafter are preferred embodiments of the invention. In the exemplary embodiments, the described components of the embodiments each represent individual features of the invention to be considered independently of one another, which each also further develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

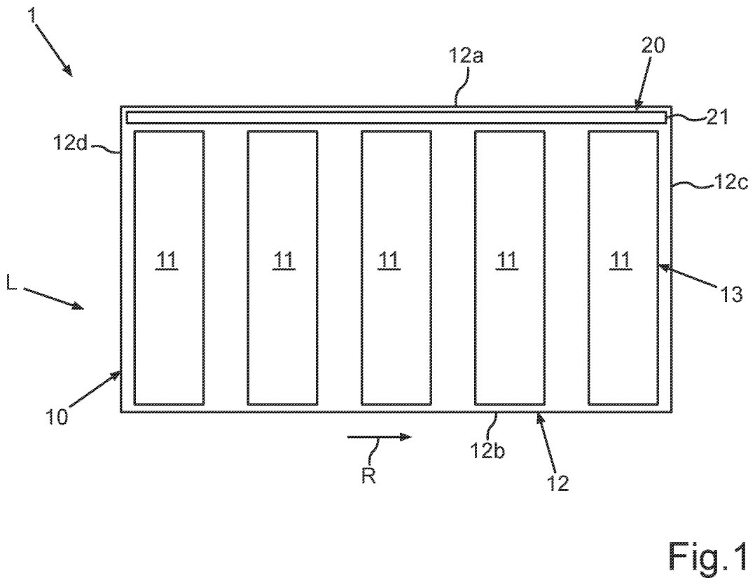

FIG. 1 shows a schematic representation of a battery arrangement 1 from a side view in a sectional representation. The battery arrangement 1 can be used, for example, as an electrical energy store for a motor vehicle. The motor vehicle can thus be a battery-electric vehicle, for example an electric vehicle or hybrid vehicle. In FIG. 1, the battery arrangement is represented in a predetermined installation position L, as it can be installed in the motor vehicle, for example.

The battery arrangement 1 has a drive battery 10 for operating the motor vehicle. By means of the drive battery 10, for example, electrical energy can be provided to an electric drive of the motor vehicle, such as an electric machine, and/or to an on-board network of the motor vehicle. The drive battery 10 is, for example, an accumulator or a secondary battery. In order to operate the motor vehicle, the drive battery 10 can provide electrical energy in the form of an electrical current and/or an electrical voltage. For this purpose, the drive battery 10 comprises at least one battery element 11. The battery element 11 can be a battery cell, i.e. a galvanic cell, for example. An electrochemistry of the battery cell can be based on lithium-ion technology, for example. The number of the battery elements 11 can be selected from a desired amount of energy to be supplied by the drive battery 10. In FIG. 1, five battery elements 11 are represented as an example. Of course, more or fewer battery elements 11 can also be used to form the drive battery 10.

To form the drive battery, the battery elements 11 can be electrically connected to one another in a suitable manner. To hold the battery elements 11, the drive battery 10 comprises a battery housing 12. In the battery housing 12, the battery elements 11 are arranged stacked next to one another in a predetermined stacking direction R, i.e. adjacent to one another. The battery elements 11 form a stacked assembly 13. In FIG. 1, the housing 12 and the battery elements 11 have a substantially rectangular cross section. The battery elements 11 can thus be present as so-called prismatic cells. In the installation position L from the side view, four housing walls of the housing 12 are represented in FIG. 1. The housing walls are a lid 12a, which is represented at the top in the installation position L according to FIG. 1, a base 12b, which is shown at the bottom opposite the lid 12a in the installation position L, and two opposite side walls 12c and 12d, which are shown on the right and left in the installation position L and support the lid 12a and the base 12b against each other.

Since the drive battery 10 can be designed as an accumulator, it is clear here that the drive battery 10 can also be supplied with electrical energy itself for recharging, for example by means of a vehicle-external charging station or by means of the electric drive through so-called recuperation. This means that the drive battery 10 or the battery elements 11 can be operated both in charging mode and in discharging mode. When the battery elements 11 are operated as intended, the respective battery element 11 may heat up, for example due to electrochemical reactions taking place in an active material that can form the electrochemistry. Under certain prerequisites or conditions, a respective battery element 11 may even overheat. A prerequisite for this can be, for example, a short circuit in one of the battery elements 11 or a mechanical defect. When overheating, it can happen that the respective battery element 11 thermally runs away. This means that the respective battery element 11 heats up until it reaches a predefined reaction temperature limit value. This can depend, for example, on a battery technology of the battery element 11 used. For example, with the aforementioned lithium-ion technology, the reaction temperature limit value may be about 84° C. If the battery element 11 reaches this reaction temperature limit value, an unstoppable or reversible electrochemical reaction can take place in the active material. This reaction quickly releases a lot of energy in the form of heat. For example, a battery element based on lithium-ion technology can release about 60 percent of its stored amount of energy in the form of thermal energy within two to three seconds when it reaches the reaction temperature limit value. As a result, the temperature of the battery element 11 can increase to up to 1,200° C., for example, depending on the electrochemistry. As a result, the battery element 11 catches fire. The condition that the battery element 11 has when the fire is present is also referred to as fire condition Z below.

The battery element 11 which is burning or with thermal runaway can release the thermal energy to the remaining battery elements 11. A so-called thermal propagation or chain reaction can occur. This means that the remaining battery elements 11 can also overheat when they are subjected to the thermal energy. In order to prevent the thermal propagation, the burning battery element 11 can be deprived of the heat energy. For this purpose, the battery arrangement 1, as shown in FIG. 1, comprises an extinguishing device 20. The extinguishing device 20 is designed to provide an extinguishing agent in the form of an aerosol to extinguish the at least one battery element 11 when the fire condition Z is present. That is, the extinguishing agent can form or have aerosol particles that can be used to extinguish the battery fire. Aerosol thus means a very fine distribution of suspended solid or liquid particles or aerosol particles in a gaseous surrounding medium, such as air.

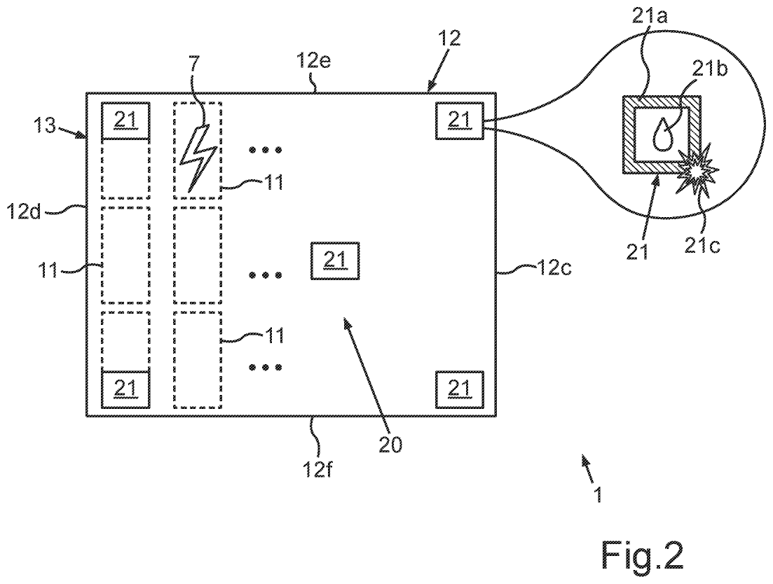

To provide the aerosol, the extinguishing device 20 comprises an extinguishing unit 21. FIG. 1 shows a first possible configuration of how the extinguishing unit 21 can be realized. In FIG. 1, the extinguishing unit 21 is designed, for example, in the form of a plate and, according to the present exemplary embodiment, is arranged along the stacking direction R on the stacked assembly 13 in the region of the lid 12a. In this case, the extinguishing unit 21 can completely or partially cover or overlap a surface of the stacked assembly 13 that extends along the stacking direction R. How the extinguishing unit 21 can be designed to provide the aerosols can be described in more detail with reference to FIG. 2.

FIG. 2 shows an alternative second possible configuration of the extinguishing device 20 according to FIG. 1. The battery arrangement 1 according to FIG. 1 is represented in a plan view or bird's eye view, i.e., for example, from the direction of the lid 12a, in a sectional representation. The housing 12, on the other hand, has a rectangular cross section, wherein only the four side walls of the housing 12 are represented, namely the side walls 12c and 12d described above and the side walls 12e and 12f. In FIG. 2, six battery elements 11 are arranged in the battery housing as an example. The battery elements 11 are arranged in several rows and columns in the plane spanned by the housing 12. The stacked assembly 13 of the battery elements 11 can thus be referred to as a stack matrix.

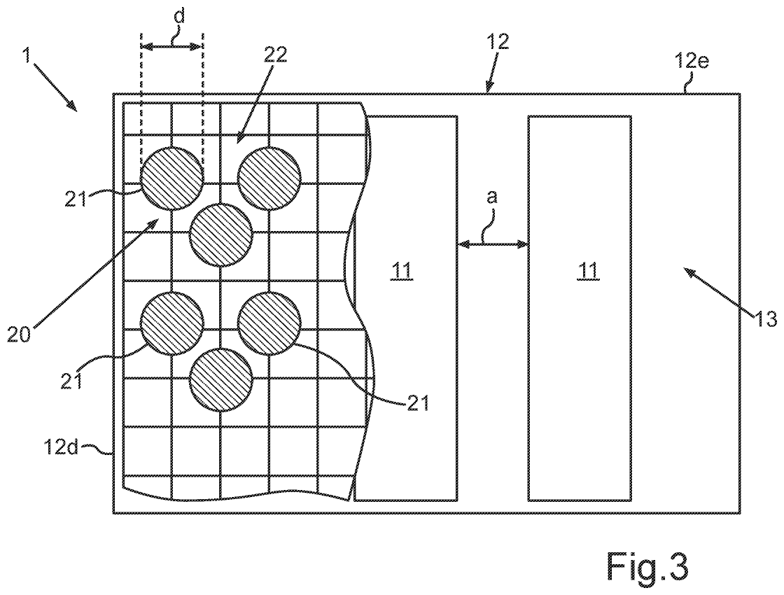

According to FIG. 2, the extinguishing device 20 comprises several or a plurality of extinguishing units 21. The extinguishing units 21 each have a rectangular cross section and are arranged in the housing 12 in a star or cross shape. That is, one of the extinguishing units 21 is arranged centrally in the battery housing 12 in plan view. Starting from the central extinguishing unit 21, the remaining extinguishing units 21 are each attached in the corners of the battery housing 12. As indicated in FIG. 2 by the dashed drawing of the battery elements 11, the extinguishing units 21 are again arranged above the battery elements 11 in the installation position L, i.e. in the region of the lid 12a. This results in the advantage that an effective direction of gravity can support the distribution of the extinguishing agent in the battery housing 12. To hold the extinguishing units 21, the extinguishing units 21 according to FIGS. 1 and 2 can be fastened to the housing lid 12a, for example. Alternatively, the extinguishing units can rest on the stacked assembly and/or be fastened to the battery elements 11. For fastening, the extinguishing units 21 can be glued or welded on, for example. A further fastening option can be explained in more detail later with reference to FIG. 3.

As shown in FIG. 2, the extinguishing units 21 have a substantially square cross section. A dimension of the extinguishing units 21 can be adapted to a dimension of the battery elements 11, for example. For example, a diameter of the respective extinguishing unit 21 can be between 1 and 10 centimeters.

To provide the aerosol extinguishing agent, the extinguishing unit 21, as shown in FIG. 2, has a housing element 21a. The housing element 21a has a cavity. So it's hollow inside. Thereby, the housing element 21a forms an envelope or container. The extinguishing agent 21b is arranged or introduced in the cavity. For example, the extinguishing agent can be a liquid such as water. In order to release the extinguishing agent 21b in the form of the aerosol, the extinguishing unit 21 has a detonation mechanism 21c. If the fire condition Z is present, this can cause a detonation of the housing element 21a. A detonation pulse of the detonation can cause the extinguishing agent 21b to be released and atomized to form aerosol particles, which form the aerosol with ambient air in the battery housing 12. The strength of the detonation pulse can determine a size, for example a diameter, of the aerosol particles. The detonation mechanism is selected, for example, so that the detonation pulse is at least locally limited to the battery housing 12 or the battery element 11 to be extinguished. It can thus be ensured that the surrounding components around the battery arrangement 1 of the motor vehicle or the remaining battery elements 11 are not impaired by the detonation.

In order to achieve the most effective possible atomization of the extinguishing agent 21b, the housing element 21a can be rigid, i.e. non-deformable, for example. That is, the housing element 21a can have a rigid or stiff material. In particular, when shaping the housing, the material can provide a low density. This ensures that no fragmentation occurs during the detonation. The material can also be temperature resistant for the fire condition Z. It can thus be ensured that the housing element 21a does not melt before the aerosol has been released. A duromer (resin) or a fiber-reinforced plastic or a polymer foam, for example, are suitable as the material for the housing element 21a. A wall thickness of the housing element 21a can be overall adapted to a dimension of the extinguishing unit 21, for example. But overall, the wall thickness can be between 0.1 and 1 centimeter, for example.

Various possible configurations are conceivable for the detonation mechanism 21c. For example, the detonation mechanism can be provided in that the extinguishing agent 21b has a predetermined coefficient of expansion, which can cause an increase in pressure in the housing element 21a when the fire condition Z is present. This increase in pressure is greater by a predetermined limit amount than a predetermined elasticity limit value of the housing element 21a can withstand. This means that the pressure can be so high that the housing breaks due to the mechanical load and detonates, for example.

A further possible configuration consists, for example, in equipping the extinguishing unit 21 with a detonation element (not represented in the figures). The detonation element can comprise an explosive or a blasting agent as a material. It is designed to detonate when the fire condition is present. The explosive can, for example, be designed to be self-igniting. That is, an energetic activation of the explosive can be provided by a trigger temperature value comprised by the fire condition. Alternatively, the detonation element can be designed for remote ignition. For this purpose, the battery arrangement 1 can have a monitoring system, for example, which can be used to monitor whether the fire condition Z is present for one of the battery elements 11. If the fire condition Z is detected, the monitoring system can provide a trigger signal to an ignition mechanism of the detonation element, thereby causing the explosive to detonate. For example, the ignition mechanism can comprise a pyrotechnic igniter.

FIG. 3 shows an alternative third possible configuration of the extinguishing device 20. In FIG. 3, a section of the battery arrangement 1 according to FIG. 2 is represented. According to the third possible configuration, the extinguishing device 20 again has a plurality of extinguishing units 21, for example six in the present case. In contrast to the configuration according to FIG. 2, however, the extinguishing units 21 have a round cross section. That is, the extinguishing units 21 can be designed in a spherical shape, for example.

For fastening or fixing the extinguishing units 21, the extinguishing device 20 comprises a fixing unit 22. According to the exemplary embodiment in FIG. 3, the fixing unit 22 is designed, for example, as a net. That is, a fixing body of the fixing unit 22 has a net-like structure. With the fixing unit 22, the extinguishing units 21 can be held at a desired position in the battery housing 12 in a normal state of the battery arrangement 1. In the present case, the extinguishing units 21 are held by the fixing unit 22, for example above the battery elements 11 in the region of the lid 12a. The fixing unit 22 is now formed, for example, to release the extinguishing units 21 from the predetermined position into the battery housing 12 when the fire condition Z is imminent. For this purpose, the fixing unit can be formed from a thermosensitive material, for example. This means that the material can have a melting point that is in a predetermined temperature value range that is not comprised by the fire condition Z. In this case, the temperature value range can be selected, for example, so that the temperature value range comprised by the fire condition is directly adjacent to it.

For example, the melting temperature, i.e. the melting point of the fixing unit 22, can be at the reaction temperature limit value which characterizes the start of the thermal runaway of the respective battery element 11. The extinguishing units 21 can thus be released into the battery housing 12 shortly before the fire condition Z occurs and can thus be provided directly to the battery elements 11. As shown in FIG. 3, a diameter D of the extinguishing units can be selected so that it is smaller than a distance a between two adjacent battery elements 11 in the stacked assembly 13. Thus, the extinguishing units 21 can, for example, reach an intermediate space between the two adjacent battery elements 11 during release. As a result, thermal propagation, i.e. overheating, of the adjacent battery elements to a battery element 11 having the heating condition Z can be prevented even more effectively.

Alternatively to the thermosensitive material of the fixing unit 22, it can be provided that the fixing unit 22 releases the extinguishing units 21 after detonation of at least one of the extinguishing units 21 on the battery housing 12. That is, a detonation pulse of the extinguishing unit 21 can destroy a structure of the fixing unit 22. For this purpose, the fixing unit can, for example, have a material whose elasticity limit value is lower than a force that the detonation pulse exerts on the fixing body of the fixing unit 22.

Overall, the examples show how an aerosol extinguishing unit for a drive battery 10 can be implemented.

1. A battery arrangement with an extinguishing device, comprising: at least one battery element which is arranged in a battery housing, and
the extinguishing device is designed to provide an extinguishing agent in the form of an aerosol for extinguishing the at least one battery element when a predetermined fire condition, which results from a fire in the at least one battery element, is present,
wherein
the extinguishing device has at least one extinguishing unit which is arranged in the battery housing, wherein the extinguishing unit comprises a housing element and the extinguishing agent, and the housing element has a cavity in which the extinguishing agent is arranged, wherein
the extinguishing unit has a detonation mechanism which is designed to cause a detonation of the housing element and a release of the extinguishing agent in the form of the aerosol when the predetermined fire condition is present.

2. The battery arrangement according to claim 1, wherein the extinguishing agent for providing the detonation mechanism has at least one material with a predetermined coefficient of expansion, and is thus designed to cause a pressure increase when the fire condition is present, which is greater by a predetermined limit amount than a predetermined elasticity limit value of the housing element.

3. The battery arrangement according to claim 1, wherein the extinguishing unit for providing the detonation mechanism has a detonation element which as a material comprises an explosive which is designed to detonate when the fire condition is present.

4. The battery arrangement according to claim 3, wherein the battery arrangement has a monitoring system which is designed to monitor at least one state variable relating to the fire condition and in the event that the state variable has a value which represents the fire condition, the monitoring system is designed to control an ignition mechanism of the detonation element with a trigger signal and to cause the detonation of the explosive.

5. The battery arrangement according to claim 1, wherein in a predetermined installation position of the battery arrangement in a motor vehicle, the extinguishing device is arranged in the battery housing in the direction of gravity above the at least one battery element, and thereby causing aerosol particles, which the extinguishing agent has in the aerosol form, to descend in the direction of gravity.

6. The battery arrangement according to claim 1, wherein the extinguishing unit forms a plate which is arranged flat in the battery housing at least on a portion of a housing wall, or the extinguishing device comprises a plurality of extinguishing units arranged at predetermined different positions in the battery housing.

7. The battery arrangement according to claim 1, wherein the extinguishing device comprises a plurality of extinguishing units and a fixing unit for the extinguishing units, wherein
the fixing unit is designed to hold the extinguishing units in a predetermined normal state of the battery arrangement in a predetermined position in the battery housing, and
the fixing unit is designed to release the extinguishing units from the predetermined position into the battery housing when the fire condition is imminent on the one hand or after detonation of at least one of the extinguishing units when the fire condition is present on the other hand.

8. The battery arrangement according to claim 1, wherein the battery arrangement has a plurality of battery elements and the extinguishing device has a plurality of extinguishing units, wherein one or more dedicated extinguishing units are assigned to each battery element.

9. The battery arrangement according to claim 8, wherein the battery arrangement has a heat protection device with a plurality of heat protection units, wherein one or more dedicated heat protection units are assigned to each battery element, wherein
the respective heat protection unit comprises a housing element and a heat protection agent, and the housing element has a cavity in which the heat protection agent is arranged, wherein the respective heat protection unit has a detonation mechanism which is designed to cause a detonation of the housing element and a release of the heat protection agent in the form of an aerosol to the assigned battery element only if the fire condition is present or imminent for another battery element not assigned to the respective heat protection unit.

10. A motor vehicle with a battery arrangement according to claim 1.

11. The battery arrangement according to claim 2, wherein the extinguishing unit for providing the detonation mechanism has a detonation element which as a material comprises an explosive which is designed to detonate when the fire condition is present.

12. The battery arrangement according to claim 2, wherein in a predetermined installation position of the battery arrangement in a motor vehicle, the extinguishing device is arranged in the battery housing in the direction of gravity above the at least one battery element, and thereby causing aerosol particles, which the extinguishing agent has in the aerosol form, to descend in the direction of gravity.

13. The battery arrangement according to claim 3, wherein in a predetermined installation position of the battery arrangement in a motor vehicle, the extinguishing device is arranged in the battery housing in the direction of gravity above the at least one battery element, and thereby causing aerosol particles, which the extinguishing agent has in the aerosol form, to descend in the direction of gravity.

14. The battery arrangement according to claim 4, wherein in a predetermined installation position of the battery arrangement in a motor vehicle, the extinguishing device is arranged in the battery housing in the direction of gravity above the at least one battery element, and thereby causing aerosol particles, which the extinguishing agent has in the aerosol form, to descend in the direction of gravity.

15. The battery arrangement according to claim 2, wherein the extinguishing unit forms a plate which is arranged flat in the battery housing at least on a portion of a housing wall, or
the extinguishing device comprises a plurality of extinguishing units arranged at predetermined different positions in the battery housing.

16. The battery arrangement according to claim 3, wherein the extinguishing unit forms a plate which is arranged flat in the battery housing at least on a portion of a housing wall, or
the extinguishing device comprises a plurality of extinguishing units arranged at predetermined different positions in the battery housing.

17. The battery arrangement according to claim 4, wherein the extinguishing unit forms a plate which is arranged flat in the battery housing at least on a portion of a housing wall, or
the extinguishing device comprises a plurality of extinguishing units arranged at predetermined different positions in the battery housing.

18. The battery arrangement according to claim 5, wherein the extinguishing unit forms a plate which is arranged flat in the battery housing at least on a portion of a housing wall, or
the extinguishing device comprises a plurality of extinguishing units arranged at predetermined different positions in the battery housing.

19. The battery arrangement according to claim 2, wherein the extinguishing device comprises a plurality of extinguishing units and a fixing unit for the extinguishing units, wherein
the fixing unit is designed to hold the extinguishing units in a predetermined normal state of the battery arrangement in a predetermined position in the battery housing, and
the fixing unit is designed to release the extinguishing units from the predetermined position into the battery housing when the fire condition is imminent on the one hand or after detonation of at least one of the extinguishing units when the fire condition is present on the other hand.

20. The battery arrangement according to claim 3, wherein the extinguishing device comprises a plurality of extinguishing units and a fixing unit for the extinguishing units, wherein
the fixing unit is designed to hold the extinguishing units in a predetermined normal state of the battery arrangement in a predetermined position in the battery housing, and
the fixing unit is designed to release the extinguishing units from the predetermined position into the battery housing when the fire condition is imminent on the one hand or after detonation of at least one of the extinguishing units when the fire condition is present on the other hand.
